(19) United States
(12) Patent Application Publication
(10) Pub. No.: US 2003/0055733 A1
(43) Pub. Date: Mar. 20, 2003

(54) Mobile digital receipts

(76) Inventors: Carl S. Marshall, Portland, OR (US); Adam T. Lake, Portland, OR (US); Rosa J. Thanasophon, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/957,890

(22) Filed: Sep. 20, 2001

(51) Int. Cl. G06F 17/60

(52) U.S. Cl. 705/24

(57) ABSTRACT

Memorialization of commercial transactions via an electronic receipt including establishing a connection between a mobile device and an electronic receipt terminal, and transmitting an electronic receipt of a commercial transaction from the electronic receipt terminal to the mobile device.

### BACKGROUND

1. Field

The claimed subject matter relates to the memorialization of commercial transactions and, more particularly, to the memorialization of commercial transactions via an electronic receipt.

2. Background Information

If a commercial transaction is memorialized, it is often memorialized utilizing a paper receipt. A paper receipt typically includes an itemized list of the property purchased, the price of that property, method of payment, the date of purchase, and possibly other details. In this context, property refers to both tangible property (for example a compact disk or sheet of plywood) and intangible property or rights to that intangible property (for example, the right to listen to a recording of a music performance or a piece of software). In this context, the term “purchase” may refer, not only to a transfer of ownership in the property, but also to the acquisition of the right to make use of the property.

A customer, as a party in the commercial transaction, may find the paper receipt less than ideal for a variety of reasons. A paper receipt may be easily lost, mutilated, or destroyed. This may become problematic when the customer wishes to use the paper receipt to organize their personal finances. If the paper receipt is damaged to a point where it ceases to memorialize the transaction, the customer may not be able to properly document or manage their expenses.

In an additional example, the loss of the paper receipt may become problematic when the customer wishes to revise the commercial transaction by returning at least some of the property purchased. Often the merchant, another party to the commercial transaction, will require that the paper receipt accompany any return of the property. Often the principle “No receipt, no refund” applies. The customer may not be able to undo or alter the purchase, because, for example, the paper receipt is often easily lost or destroyed. In addition, when the customer presents the paper receipt, the merchant frequently makes a memorialization of the alteration to the transaction on the original paper receipt. This new memorialization, often performed by hand, frequently obscures the information found on the paper receipt. Alternately, the merchant may treat the return as a second transaction and issue a second separate paper receipt. Now the customer is usually expected to preserve both the original paper receipt and the second return receipt. Often customers find this inconvenient. Similar difficulties arise when the customer wishes to, for example, exchange the property purchased for other property, receive a rebate, or receive a discount of further transactions. A need, therefore, exists for an improved system or technique for memorializing a commercial transaction.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a flowchart of the memorialization of a commercial transaction in accordance with the claimed subject matter;

FIG. 2 is a flowchart describing utilizing a memorialization of a commercial transaction in accordance with the claimed subject matter; and

FIG. 3 is a diagram of a system capable of the memorialization of a commercial transaction in accordance with the claimed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

In this context, an electronic receipt is a memorialization of at least one commercial transaction that is represented in an intangible but identifiable form. In one embodiment an electronic receipt includes, but is not limited to, a digital data file, which may be transmitted by and stored on a medium readable by electronic devices. Of course, one skilled in the art will realize that a number of electronic receipts may be grouped together in a single data file. An illustration, not intended to be limiting in any way, of an electronic receipt may be a data file that includes a list of property purchased, the price that property was purchased for, the date of the transaction, and the digital signature of the merchant from whom the property was purchased. This data file may also, for example, include a unique identifier. One skilled in the art will realize that it may be desirable to utilize other data as part of the electronic receipt. One skilled in the art will realize that a digital signature may take many forms, such as, for example, a cryptographic key, a unique formatting style, or possibly a plain text identifier. One skilled in the art will further realize that a technique for controlling the validity of an electronic receipt may be valuable. Such a technique may involve the prevention of unauthorized editing of the receipt or unauthorized duplication of the receipt. Examples of such techniques may include, but are not limited to, encryption, use of a checksum, or maintaining a merchant database of electronic receipts.

In this context, an electronic receipt terminal comprises a device, at least one of whose functions is to transmit an electronic receipt of a commercial transaction to another device. Typically an electronic receipt terminal may also include, but is not limited to, the ability to receive an electronic receipt of a commercial transaction from another device. An illustrative example of an electronic receipt terminal is a device, which may be coupled to a merchant's point of sales terminal, that receives information about a commercial transaction from the point of sale terminal, creates an electronic receipt of that transaction, and transmits the electronic receipt to another device. One skilled in the art will realize that the electronic receipt terminal may be integrated into the merchant's point of sales terminal. Alternately, one skilled in the art will also understand that the electronic receipt terminal may be physically remote but communicatively coupled to the device that creates or edits the electronic receipt.

In this context, a mobile device comprises a device, with a storage element, that is capable of being readily moved from place to place and has the capability to transmit information. Typically, the weight of a mobile device is on the order of magnitude of a few pounds or ounces. Generally a mobile device may weigh less than five pounds. A mobile device may, but is not limited to, include a component to process instructions stored in its storage element. Examples of mobile devices, which the claimed subject matter is not limited to, may include a cellular phone, a personal digital assistant (PDA), a smart card, a personalized memory device, a wristwatch or a palmtop personal computer. Of course, one skilled in the art will realize other devices, which may be considered mobile devices in this context.

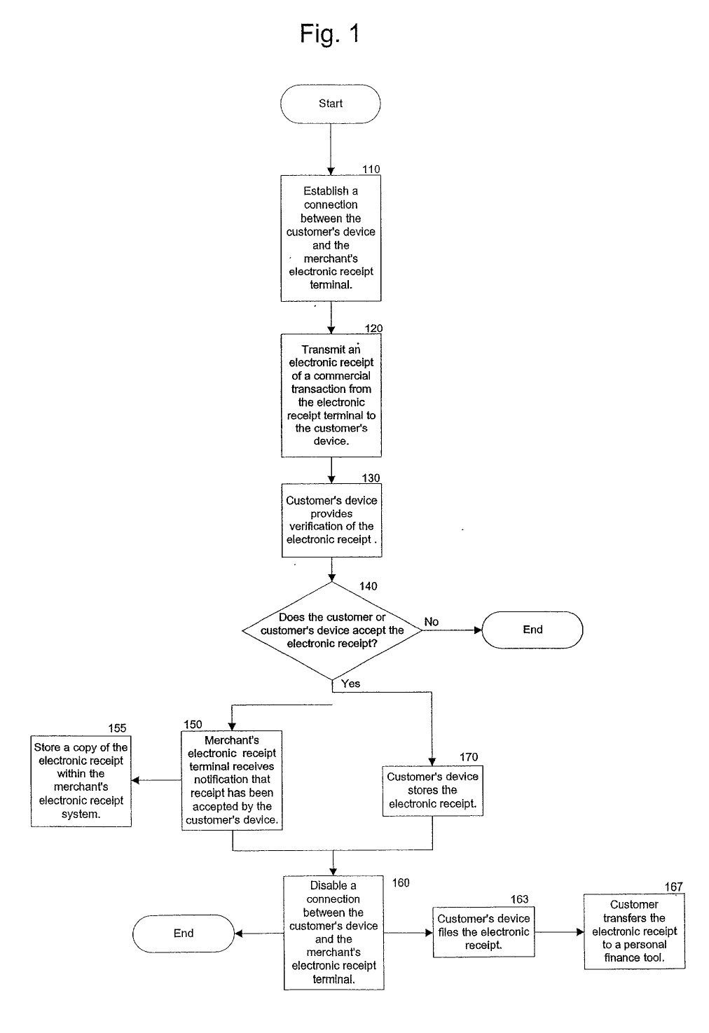

FIG. 1 is a flowchart of a technique for memorializing a commercial transaction illustrating an embodiment of the claimed subject matter. FIG. 1 illustrates an embodiment where a merchant and a customer wish to memorialize a commercial transaction. Of course, one skilled in the art will realize that this technique may be extended to accommodate more than two parties. In addition, the claimed subject matter is not limited to this one embodiment illustrating a two party example.

As illustrated by action 110, once a merchant and a customer wish or might wish to memorialize a commercial transaction, they may establish a connection between the customer's mobile device and the merchant's electronic receipt terminal. As a more specific example, after purchasing groceries, the grocer's terminal may sense that the customer has a cell phone capable of receiving electronic receipts. Using a wireless protocol, the grocer's terminal may establish a connection with the customer's cell phone. One skilled in the art will realize that a connection between the merchant's electronic receipt terminal and the customer's mobile device may be made through a variety of techniques. For example, a few possible, but not exhaustive, techniques may include an auto-sensing wireless protocol, a manually initiated wireless protocol, a docking station or a physical cable between the terminal and the mobile device.

In addition, one skilled in the art will realize that it may be desirable to establish the connection, and any transmissions across that connection, in a substantially secure fashion which, at least partially, deters eavesdropping, interception, or tampering with any transmitted data. For example, a few possible, but not exhaustive, techniques to secure the connection may include the use of a cryptographic protocol, a physical cable between the terminal and the mobile device, or a narrowly focused beam. However, one skilled in the art will realize other possible techniques.

As illustrated by action 120, once the electronic receipt has been created, it may be transmitted from the electronic receipt terminal to the customer's mobile device. To continue the previous, non-limiting specific example, once the sale has been completed, the grocer's terminal may generate an electronic receipt and transmit it to the customer's cell phone. One skilled in the art will realize that the electronic receipt terminal need not generate the electronic receipt. The receipt may, as an example, be generated by a point of sales device, which is coupled to the electronic receipt terminal. For example, the grocer may have attached an electronic receipt terminal to their legacy cash registers.

One skilled in the art will also realize that electronic receipt need not be generated between actions 110 and 120. The receipt may have been generated previously and is now being transferred to the mobile device. In addition, one skilled in the art will understand that the electronic receipt need not be created from this commercial transaction. The electronic receipt may be edited or updated from a previous transaction. For example, the electronic receipt may have been updated as a result of a refund or exchange, and is presently being transmitted to the mobile device.

As illustrated by action 130, the customer's mobile device may provide verification of the electronic receipt. In the specific example, the customer's cell phone may automatically check to confirm that all the parts of the electronic receipt were properly transmitted by the grocer's electronic receipt terminal. One skilled in the art will understand that a variety of techniques may be utilized to verify the receipt. Also, one skilled in the art will understand that a variety of techniques may be used in the case where an electronic receipt is not properly verified, such as, for example, requesting that the electronic receipt be retransmitted, or, possibly, marking the receipt as incomplete or otherwise defective.

As illustrated by action 140, in some embodiments of the technique, the customer may be asked to accept or reject the receipt. For example, in much the way a waiter shows a patron the bill for dinner before payment is accepted, the customer may be asked to assent to the receipt before payment is rendered. In the above example, the customer may wish to verify that the correct price was paid for each item before leaving the grocer's store. One skilled in the art will realize that there are a large number of reasons customer acceptance of a receipt may be desirable and implemented. The above are merely a few examples.

In addition, one skilled in the art will understand that the customer may or may not be expected to actively verify or assent to the receipt. Instead, as an example, the mobile device may be programmed with a set of rules utilized in automatically accepting electronic receipts. One skilled in the art will realize that varying degrees of customer customization of these possible rules is possible. A technique may, for example, involve automatic acceptance of a receipt in some circumstances and a manual acceptance of the receipt by the customer in other circumstances.

As illustrated by action 150, the customer's device may notify the electronic receipt terminal that receipt has been accepted. Action 155 illustrates an embodiment where the merchant may store a copy of the electronic receipt in their electronic receipt system. Continuing the grocer example, the grocer may store the electronic receipt in a database to monitor buying habits, for example, or for other possible reasons. One skilled in the art will understand that the electronic receipt stored in the merchant's electronic receipt system need not be identically formatted to the one transmitted to the customer's mobile device. Some information may be more or less desirable to the merchant and, therefore, may affect the electronic receipt stored by the merchant.

In this context, an electronic receipt system comprises a system that includes an electronic receipt terminal and is capable of generating an electronic receipt. In addition to an electronic receipt terminal, an electronic receipt system may include, but is not to, other devices, such as, for example, a database, and a point of sales terminal. One skilled in the art will realize that the components of an electronic receipt system, if there are more than one, may be physically remote from one another.

As illustrated by action 170, in the case where the customer has accepted the electronic receipt, the electronic receipt is stored in the customer's mobile device. Action 160 illustrates the customer's mobile device becoming disconnected from the merchant's electronic receipt terminal. As an example, as the customer exits the grocer's store, the customer's mobile device might exceed the range of the wireless protocol and the connection between the customer's cell phone and the grocer's terminal would cease. The customer would leave the store with the electronic receipt stored in their cell phone. One skilled in the art will realize that some communication techniques may be used where the physical location, a hence range, of the customer's device is not determinative of the ability to disable a communication. For example, if the communication technique was, for example, a short telephone call, the disabling the connection might not depend on the physical distance between the merchant's electronic receipt terminal and the customer's mobile device. One skilled in the art will realize that, just as there are a variety of ways to perform action 110, there are a variety of techniques, which may be utilized to disable a connection between the mobile device and the terminal.

As illustrated by actions 163 and 167 the customer may, optionally, file the electronic receipt or transfer the electronic receipt into, or at least into a format accessible to, a personal finance application program, such as, for example, Intuit® Quicken® or Microsoft® Money, which may operate on a processing system, such as, for example, a computer. One skilled in the art will understand that the receipt may be filed based upon a configurable set of rules, such as, for example, automatically filing the electronic receipt based upon date, the merchant, total of the purchase price, type of purchase or possibly by geographic location. Of course, these are merely a few examples. Alternately, one skilled in the art will understand that the customer may manually file the electronic receipts. Also, one skilled in the art will realize that the entire electronic receipt may not be transferred to the personal finance tool, merely at least a portion of the information contained in the receipt may be transmitted to the tool.

In addition, one skilled in the art will understand that the electronic receipt or at least a portion of the information contained therein may be transferred to a more stationary device. For example, a customer may wish to transfer all of their electronic receipts to a personal computer or other medium, such as, for example, printing them to paper. One skilled in the art would also understand that a technique to provide security and control of the duplication of the electronic receipt might be desirable.

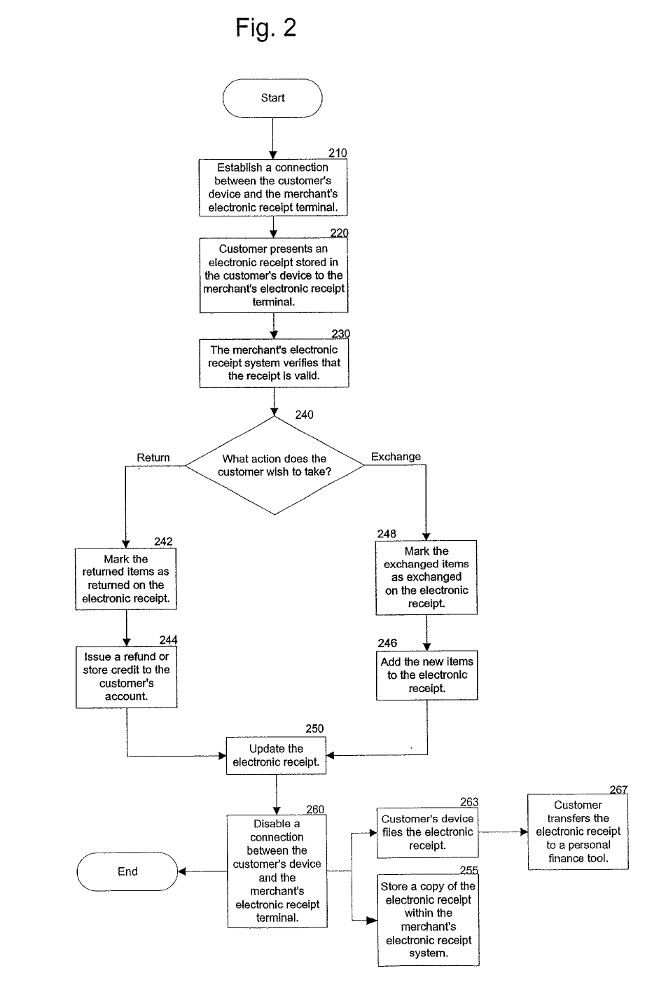

FIG. 2 is a flowchart of a technique for utilizing a memorialization of a commercial transaction illustrating an embodiment of the claimed subject matter. FIG. 2 illustrates an embodiment where a customer wishes to utilize a memorialization a commercial transaction in a subsequent commercial transaction. Of course, one skilled in the art will realize that this technique may be extended to accommodate more than two parties. In addition, the claimed subject matter is not limited to this one embodiment illustrating a two party example.

As illustrated by action 210, once a merchant and a customer wish or might wish to utilize a memorialization of a commercial transaction, they may establish a connection between the customer's mobile device and the merchant's electronic receipt terminal. As a more specific example, upon approaching the customer service desk of a grocery store, the grocer's terminal may sense that the customer has a cell phone capable of receiving electronic receipts. Using a wireless protocol, the grocer's terminal may establish a connection with the customer's cell phone. One skilled in the art will realize that a connection between the merchant's electronic receipt terminal and the customer's mobile device may be made through a variety of techniques. For example, a few possible, but not exhaustive, techniques may include an auto-sensing wireless protocol, has illustrated above, a manually initiated wireless protocol, or a physical cable between the terminal and the mobile device.

As illustrated by action 220, a customer may present an electronic receipt stored in the customer's mobile device to the merchant's electronic receipt terminal. To continue the above specific, non-limiting example, a customer wishing to return a defective mop purchased the previous day, may present the grocer's terminal with an electronic receipt of the commercial transaction created when the mop was purchased. One skilled in the art will understand that the receipt may be presented to the merchant's terminal by transmitting the electronic receipt, in whole or in part, to the merchant's terminal. For example, it may be desirable to merely transmit the unique identifier of the electronic receipt to the terminal and have the merchant's electronic receipt system retrieve it's copy of the electronic receipt; however, one skilled in the art will realize other possibilities.

As illustrated by action 230, the merchant's electronic receipt system may verify that the electronic receipt is valid. One skilled in the art will understand that the merchant may, for example, wish to verify that the receipt has not been forged, altered in an unauthorized manner, previously presented, or is invalid due to the merchant's return policy, such as, for example, referring to a commercial transaction older than 90 days; however, these are merely a few examples which the claimed subject matter is not limited to. One skilled in the art will understand that the method of validation will be dependent upon the format and protocol utilized to create the electronic receipt, but may include techniques, such as, for example, utilizing a checksum, comparing the electronic receipt to a known valid copy of the receipt, or possibly altering the unique identifier associated with the receipt every time the receipt is copied. One skilled in the art will realize that these are merely a few examples and not an exhaustive list of all the techniques contemplated by the claimed subject matter.

As shown by action 240, further actions may be dependent upon the commercial transaction the customer wishes to engage in. For example, if the customer wished to return an item, action 242 illustrates that the merchant may mark the items returned as returned on the electronic receipt and, as shown by action 244, issue a refund or store credit to the customer's account. Continuing the above specific example, the grocer might edit the electronic receipt to show that the defective mop was returned and credit the customer's credit card, possibly getting the customer's account number from the electronic receipt, the appropriate amount.

Alternately, if the customer wished to exchange an item, action 248 illustrates marking the exchanged items as exchanged on the receipt and, action 246 illustrates, adding the new items onto the electronic receipt. In the above specific example, if the customer had wished to exchange the defective mop, the grocer might have marked the defective mop as exchanged and edited the electronic receipt to show which new mop the received, the time they received the new mop, and any other desired information.

One skilled in the art will understand that these are merely two examples of the types of transactions and procedures that may involve the utilization of an electronic memorialization of a commercial transaction. Other uses may include, for example, such as, receiving a rebate, or receiving a discount on property acquired in the future; however, one skilled in the art will understand that other forms of commercial transactions are contemplated. One skilled in the art will also realize that the various actions preformed as part of each commercial transaction may differ, and that the above embodiment merely illustrate two possible sets of actions. It is contemplated that in one embodiment, for example, the first electronic receipt may be destroyed and a second electronic receipt issued, the first electronic receipt may not be altered and a second electronic receipt issued, or that the first electronic receipt may be edited; however, these are merely a few, non-exhaustive examples of embodiments of the claimed subject matter.

Action 250 illustrates updating the electronic receipt to reflect the second commercial transaction. This may involve transmitting the edited, or second, electronic receipt to the customer's mobile device as illustrated by actions 120 through 150 (FIG. 1). One skilled in the art will understand that the mobile device may utilize a variety of techniques to store the updated electronic receipt, such as, for example, deleting the first electronic receipt and storing the updated electronic receipt, storing both the first and second electronic receipts, or, possibly, storing one of the electronic receipts and the incremental differences between the two receipts; however, these are merely a few non-limiting examples of techniques which may be utilized. Actions 260, 263, 267, and 255 illustrate actions analogous to actions 160, 163, 167, and 155, respectively. However, as discussed previously, one skilled in the art will realize that other actions may be desired.

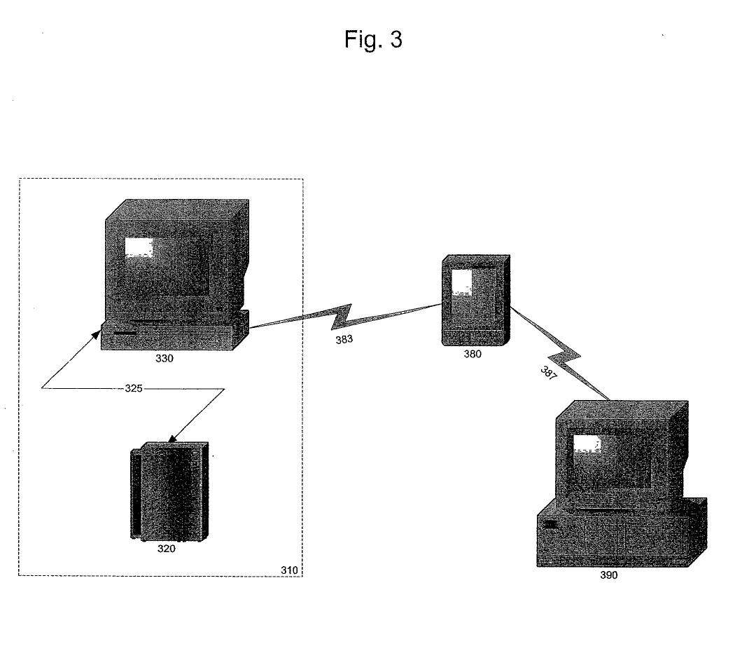

FIG. 3 is a diagram of a system capable of the memorialization of a commercial transaction in accordance with the claimed subject matter. Of course, one skilled in the art will realize that this system may be extended to accommodate more than two parties. In addition, the claimed subject matter is not limited to this one embodiment illustrating a two party example.

Such a system may include an electronic receipt system 310, which includes an electronic receipt terminal 330. Electronic receipt terminal 330 may be capable of being in communication with a mobile device 380. In addition, while in communication with mobile device 380, the electronic receipt terminal 330 may be capable of transmitting an electronic receipt of a commercial transaction to the mobile device 380. One skilled in the art will realize that various embodiments may include, for example, an electronic receipt terminal with the capability to initiate communication with the mobile device 380. While other embodiments may include, for example, an electronic receipt terminal with the capability to respond to a communication initiated by the mobile device 380. While, yet another embodiment may include, for example, an electronic receipt terminal with the capability to both initiate and respond to a communication with by the mobile device 380.

Electronic receipt system 310 may also include the capability to generate or update an electronic receipt of a commercial transition. One skilled in the art will understand that the electronic receipt may generated by a variety of components within the electronic receipt system. For example, components, such as, the electronic receipt terminal, a point of sales terminal or an electronic receipt storage device may generate the electronic receipt. One skilled in the art will also understand that the electronic receipt may generated by one or more components of the system working individual or in concert.

In one embodiment, electronic receipt terminal 330 may be in communication, via coupling 325, with electronic receipt storage device (ERSD) 320. Electronic receipt terminal 330 may be capable of transmitting electronic receipts to and from ERSD 320. One skilled in the art will realize that electronic receipt terminal 330 may only transmit at least on portion of the information contained in the electronic receipt to or from ERSD 320. ERSD 320 may include a device having at least the function of storing electronic receipts, either in whole or in part. One skilled in the art will realize that ERSD 320 and electronic receipt terminal 330 may be physically remote from one another.

Another embodiment of the system illustrated in FIG. 3 may include a mobile device that is cable of communicating with electronic receipt terminal 330, via connection 383, and is capable of storing electronic receipts. One skilled in the art will understand that connection 383 may take many forms, such as, for example, an auto-sensing wireless signal, a manually established wireless connection, or a physical coupling between mobile device 380 and electronic receipt terminal 330.

In addition, one skilled in the art will realize that it may be desirable to establish connection 383, and any transmissions across that connection, in a substantially secure fashion which, for example, at least partially, deters eavesdropping, interception, or tampering with any transmitted data. For example, a few possible, but not exhaustive, techniques to secure the connection may include the use of a cryptographic protocol, a physical cable between the terminal and the mobile device, or a narrowly focused beam. However, one skilled in the art will realize other possible techniques.

In one embodiment, mobile device 380 may be cable of transmitting an electronic receipt from the mobile device to electronic receipt terminal 330. Electronic receipt system 310 may be cable of then verifying the validity of the received electronic receipt. One skilled in the art will understand that a merchant may, for example, wish to verify that the receipt has not been forged, altered in an unauthorized manner, previously presented, or is invalid due to the merchant's return policy, such as, for example, referring to a commercial transaction older than 90 days; however, these are merely a few examples which the claimed subject matter is not limited to. One skilled in the art will understand that the method of validation will be dependent upon the format and protocol utilized to create the electronic receipt, but may include techniques, such as, for example, utilizing a checksum, comparing the electronic receipt to a known valid copy of the receipt, or possibly altering the unique identifier associated with the receipt every time the receipt is copied. One skilled in the art will realize that these a merely a few examples and not an exhaustive list of all the techniques contemplated by the claimed subject matter.

In another embodiment, mobile device 380 may be capable of transmitting an electronic receipt or at least part of the information contained in the electronic receipt, via connection 387, to primarily stationary device 390. Primarily stationary device 390 may include a personal finance application program operating on a processing system, such as, for example, a computer, or anther form of financial application. One skilled in the art will understand that a primarily stationary device may include, such as, for example, a desktop computer, a laptop computer, a file server, a printer or a dedicated financial management device; however, these are merely a few examples to which the claimed subject matter is not limited by. In addition, one skilled in the art will realize that the forms of connection 387 and security issues related to connection 387 are analogous to connection 383.

The techniques described herein are not limited to any particular hardware or software configuration; they may find applicability in any computing or processing environment. The techniques may be implemented in hardware, software or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact read only memory (CD-ROM), digital versatile disk (DVD), hard disk, magnetic disk or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

What is claimed is:

1: A method comprising:
establishing a connection between a mobile device and an electronic receipt terminal; and
transmitting an electronic receipt of a commercial transaction from the electronic receipt terminal to the mobile device.

2: The method of claim 1, further comprising generating an electronic receipt of a commercial transaction.

3: The method of claim 2, wherein generating an electronic receipt includes generating at least one of an itemized list of property acquired during the commercial transaction, the prices paid for the property, the time the commercial transaction was memorialized, and a unique identifier.

4: The method of claim 1, further comprising storing a copy of the electronic receipt within an electronic receipt system.

5: The method of claim 1, wherein transmitting comprises transmitting the electronic receipt in a substantially secure fashion.

6: The method of claim 5, wherein transmitting the electronic receipt in a substantially secure fashion comprises utilizing a cryptographic protocol.

7: The method of claim 5, wherein transmitting the electronic receipt in a substantially secure fashion comprises utilizing a physical cable to communicate the electronic receipt.

8: The method of claim 1, wherein establishing a connection comprises one of the techniques selected from a group including auto-sensing a wireless signal from the electronic receipt terminal, physically coupling the mobile device and the electronic receipt terminal, and manually establishing a wireless connection.

9: A method comprising:
establishing a connection between a mobile device and an electronic receipt terminal; and
receiving an electronic receipt of a commercial transaction transmitted from the electronic receipt terminal to the mobile device.

10: The method of claim 9, further comprising storing the electronic receipt by the mobile device.

11: The method of claim 10, further comprising filing the electronic receipt by the mobile device based upon a configurable set of rules.

12: The method of claim 11, wherein the configurable set of rules comprises one of the filing schemes selected from a group including filing by date, filing by merchant, filing by total purchase price, filing by type of purchase and filing by geographic location.

13: The method of claim 10, further comprising transferring at least part of the information contained in the electronic receipt from the mobile device to a primarily stationary device.

14: The method of claim 10, transferring at least part of the information contained in the electronic receipt from the mobile device into a format accessible by a personal finance application program.

15: The method of claim 9, further comprising accepting the electronic receipt received from the electronic receipt terminal.

16: The method of claim 15, wherein accepting the electronic receipt comprises a user actively verifying and assenting to the electronic receipt.

17: The method of claim 15, wherein accepting the electronic receipt comprises verifying and assenting to the electronic receipt based upon a set of substantially configurable rules.

18: The method of claim 9, wherein receiving the electronic receipt comprises transmitting, by the mobile device, an acknowledgement of acceptance to the electronic receipt terminal.

19: A method comprising:
utilizing an electronic receipt of a first commercial transaction and
providing an electronic receipt of a second commercial transaction.

20: The method of claim 19, further comprising creating an updated electronic receipt to reflect the second commercial transaction.

21: The method of claim 20, wherein updating comprises marking any property that was part of the first commercial transaction and returned as part of the second commercial transaction as returned and adding any property acquired as part of the second commercial transaction to the electronic receipt.

22: The method of claim 21, further comprising transmitting the updated electronic receipt from an electronic receipt terminal to a mobile device.

23: The method of claim 19, further comprising verifying, by an electronic receipt terminal, the validity of the electronic receipt of the first commercial transaction.

24: The method of claim 23, wherein verifying comprises utilizing a unique identifier associated with the electronic receipt.

25: The method of claim 23, wherein verifying comprises confirming that the electronic receipt has not been edited by an unauthorized source since the creation of the electronic receipt.

26: The method of claim 25, wherein confirming comprises utilizing a checksum.

27: A method comprising:
presenting an electronic receipt of a commercial transaction stored in a mobile device to an electronic receipt terminal.

28: The method of claim 27, further comprising utilizing the electronic receipt of a first commercial transaction in a second commercial transaction.

29: The method of claim 28, wherein the second commercial transaction comprises one of the transactions selected from a group including returning property, exchanging property, receiving a rebate, and receiving a discount on property acquired in the future.

30: The method of claim 28, further comprising deleting the mobile device's copy of the electronic receipt after an updated electronic receipt has been received.

31: The method of claim 27, further comprising establishing a connection between the mobile device and the electronic receipt terminal.

32: An electronic receipt system comprising:
an electronic receipt terminal, and
an electronic receipt storage device, which is capable of, during operation, storing at least part of the information contained in an electronic receipt of a commercial transaction;
wherein the electronic receipt system is capable of generating the electronic receipt, and, during operation, being in communication with a mobile device so as to facilitate the transmittal of the electronic receipt to the mobile device.

33: The system of claim 32, wherein the electronic receipt terminal, during operation, is in communication with the mobile device via a connection comprising one of the connections selected from a group including an auto-sensing wireless signal, a physically coupling between the mobile device and the electronic receipt terminal, and a manually established a wireless connection.

34: The system of claim 32, wherein the electronic receipt includes at least one of an itemized list of the property involved in the commercial transaction, the price paid for the property, and a summary of the commercial transaction.

35: The system of claim 34, wherein the electronic receipt further includes a unique identifier.

36: The system of claim 32, wherein the electronic receipt system is capable of, during operation, updating an electronic receipt of a first commercial transaction to reflect a second commercial transaction.

37: The system of claim 36, wherein electronic receipt system is capable of, during operation, receiving an electronic receipt transmitted from the mobile device to the electronic receipt terminal.

38: The system of claim 37, wherein the electronic receipt system is capable of, during operation, of verifying the validity of the electronic receipt transmitted by the mobile device.

39: The system of claim 38, wherein verifying the validity of the electronic receipt transmitted by the mobile device comprises utilizing a checksum.

40: The system of claim 32, wherein the electronic receipt terminal, during operation, communicates with the mobile device in a substantially secure fashion.

41: The system of claim 40, wherein the electronic receipt terminal, during operation, communicates with the mobile device in a substantially secure fashion comprising one of the secure fashions selected from a group including a cryptographic protocol, a physical cable to communicate a signal, and a narrowly focused wireless signal.

42: An apparatus comprising:
a mobile device capable of, during operation, receiving an electronic receipt of a commercial transaction.

43: The apparatus of claim 42, wherein the mobile device comprises one of the devices selected from a group including a cellular phone, a personal digital assistant (PDA), a smart card, a personalized memory device, a wristwatch or a palmtop personal computer.

44: The apparatus of claim 42, wherein the electronic receipt is, during operation, transmitted from an electronic receipt terminal to the mobile device.

45: The apparatus of claim 42, wherein the mobile device is capable of storing at least part of the information contained in the electronic receipt.

46: The apparatus of claim 45, wherein the mobile device is capable of transmitting at least part of the information contained in the electronic receipt to a primarily stationary device.

47: The apparatus of claim 46, wherein the primarily stationary device includes a processing device capable of executing instructions for a personal finance application program.

48: The apparatus of claim 45, wherein the mobile device is further capable of filing at least part of the information contained in the electronic receipt based upon a configurable set of rules.

49: The apparatus of claim 45, wherein the mobile device is further capable of transmitting at least part of the information contained in the electronic receipt to an electronic receipt terminal in order to facilitate a second commercial transaction.

50: The apparatus of claim 49, wherein the mobile device is further capable of updating at least part of the information contained in the electronic receipt to reflect the second commercial transaction.

51: An article comprising:
a storage medium having a plurality of machine readable instructions, wherein when the instructions are executed by a processor, the instructions provide for
establishing a connection between a mobile device and an electronic receipt terminal; and
transmitting an electronic receipt of a commercial transaction from the electronic receipt terminal to the mobile device.

52: The article of claim 51, further comprising instructions for generating an electronic receipt of a commercial transaction.

53: The article of claim 52, further comprising instructions wherein generating an electronic receipt includes at least one of generating an itemized list of property acquired during the commercial transaction, the prices paid for the property, the time the commercial transaction was memorialized, and a unique identifier.

54: The article of claim 51, further comprising instructions for storing a copy of the electronic receipt within an electronic receipt system.

55: The article of claim 51, further comprising instructions wherein transmitting comprises transmitting the electronic receipt in a substantially secure fashion.

56: The article of claim 51, further comprising instructions wherein establishing a connection comprises one of the techniques selected from a group including auto-sensing a wireless signal from the electronic receipt terminal, physically coupling the mobile device and the electronic receipt terminal, and manually establishing a wireless connection.

57: An article comprising:
a storage medium having a plurality of machine readable instructions, wherein when the instructions are executed by a processor, the instructions provide for
establishing a connection between a mobile device and an electronic receipt terminal; and
receiving an electronic receipt of a commercial transaction transmitted from the electronic receipt terminal to the mobile device.

58: The article of claim 57, further comprising instructions for storing the electronic receipt by the mobile device.

59: The article of claim 58, further comprising instructions for filing the electronic receipt by the mobile device based upon a configurable set of rules.

60: The article of claim 59, further comprising instructions wherein the configurable set of rules comprises one of the filing schemes selected from a group including filing by date, filing by merchant, filing by total purchase price, filing by type of purchase and filing by geographic location.

61: The article of claim 58, further comprising instructions for transferring at least part of the information contained in the electronic receipt from the mobile device to a primarily stationary device.

62: The article of claim 58, further comprising instructions for transferring at least part of the information contained in the electronic receipt from the mobile device into a format accessible by a personal finance application program.

63: The article of claim 57, further comprising instructions for accepting the electronic receipt received from the electronic receipt terminal.

64: The article of claim 63, further comprising instructions wherein accepting the electronic receipt comprises verifying and assenting to the electronic receipt based upon a set of substantially configurable rules.

65: An article comprising:
a storage medium having a plurality of machine readable instructions, wherein when the instructions are executed by a processor, the instructions provide for
utilizing an electronic receipt of a first commercial transaction and
providing an electronic receipt of a second commercial transaction.

66: The article of claim 65, further comprising instructions for creating an updated electronic receipt to reflect the second commercial transaction.

67: The article of claim 66, further comprising instructions for transmitting the updated electronic receipt from an electronic receipt terminal to a mobile device.

68: The article of claim 65, further comprising instructions for verifying, by an electronic receipt terminal, the validity of the electronic receipt of the first commercial transaction.

69: The article of claim 68, further comprising instructions wherein verifying comprises utilizing a unique identifier associated with the electronic receipt.

70: The article of claim 65, further comprising instructions wherein verifying comprises confirming that the electronic receipt has not been edited by an unauthorized source since the creation of the electronic receipt.

71: An article comprising:
a storage medium having a plurality of machine readable instructions, wherein when the instructions are executed by a processor, the instructions provide for
presenting an electronic receipt of a commercial transaction stored in a mobile device to an electronic receipt terminal.

72: The article of claim 71, further comprising instructions for utilizing the electronic receipt of a first commercial transaction in a second commercial transaction.

73: The article of claim 72, further comprising instructions wherein the second commercial transaction comprises one of the transactions selected from a group including returning property, exchanging property, receiving a rebate, and receiving a discount on property acquired in the future.

74: The article of claim 72, further comprising instructions for deleting the mobile device's copy of the electronic receipt after an updated electronic receipt has been received.
